(19) United States
(12) Patent Application Publication
(10) Pub. No.: US 2020/0086425 A1
(43) Pub. Date: Mar. 19, 2020

(54) METHOD OF PREPARING A ZINC COATED SHEET METAL PIECE FOR WELDING

(71) Applicant: Shiloh Industries, Inc., Valley City, OH (US)

(72) Inventors: Michael Telenko, JR., Canton, MI (US); Sam A. Kassoumeh, Canton, MI (US)

(21) Appl. No.: 16/573,444

(22) Filed: Sep. 17, 2019

Related U.S. Application Data
(60) Provisional application No. 62/732,202, filed on Sep. 17, 2018.

(51) Int. Cl. B23K 26/36; B23K 26/082

(52) U.S. Cl. CPC B23K 26/36; B23K 2103/08; B23K 26/082

(57) ABSTRACT

A method of preparing zinc coated sheet metal pieces for welding, along with welded sheet metal assemblies formed from the prepared zinc coated sheet metal pieces. In one embodiment, a scanning beam of a laser is directed at an edge portion of the sheet metal piece such that a portion of the scanning beam is configured to impact the zinc coating layer at the edge portion. The laser is pulsed in a series of ablating pulses at the edge portion, with the ablating pulses creating an ablation plume that includes ablated material from the zinc coating layer of the primary surface and the peripheral surface of the edge portion. The ablation plume is analyzed, and ablation and analyzing continues until a threshold of at least one constituent in the ablation plume or the analysis plume is met or exceeded. One or more operating parameters of the laser are adjusted based on the analysis of the ablation plume or analysis plume. In some embodiments, two sheet metal pieces are simultaneously prepared.

### CROSS-REFERENCE TO RELATED APPLICATIONS

This application claims the benefit of U.S. provisional application Ser. No. 62/732,202 filed on Sep. 17, 2018, the contents of which is hereby incorporated by reference in its entirety.

### FIELD

The present disclosure relates to welding sheet metal pieces, and more particularly, to preparing zinc coated sheet metal pieces for welding, such as a coated boron steel alloy, a dual phase steel, a press hardened steel (PHS), a high-strength low-alloy (HSLA) steel, an ultra-high-strength steel (DHSS), an advanced high-strength steel (AHSS), or a generation 3 steel.

### BACKGROUND

There is a push in the automotive industry to use lighter weight materials for fuel economy purposes, yet many of the strength and rigidity requirements remain the same. Advanced high strength steels are desirable for these uses. However, they are often coated with materials such as zinc to enhance corrosion resistance. When the sheet metal pieces are laser welded, the zinc coating can cause liquid metal embrittlement (LME). Molten zinc can penetrate grain boundaries in the steel sheet metal piece, causing unwanted crack propagation and weakness near the weld joint. Targeted removal of the zinc coating while maintaining the structural integrity of the sheet metal piece is desirable.

### SUMMARY

In accordance with one embodiment, there is provided a method of preparing a sheet metal piece for welding, the sheet metal piece having a zinc coating layer, the method comprising the steps of: directing a beam of a laser at an edge portion of the sheet metal piece such that a portion of the beam is configured to impact the zinc coating layer at the edge portion, wherein the edge portion includes at least a part of a primary surface of the sheet metal piece, at least a part of a secondary surface of the sheet metal piece, and at least a part of a peripheral surface of the sheet metal piece, the peripheral surface being situated between the primary surface and the secondary surface; pulsing the laser in a series of ablating pulses at the edge portion, wherein the ablating pulses create an ablation plume that includes ablated material from the zinc coating layer located at the primary surface and ablated material from the zinc coating layer located at the peripheral surface; analyzing the ablation plume for the series of ablating pulses or analyzing an analysis plume created by a series of analysis pulses at the edge portion; continuing the ablation and analyzing step until a threshold of at least one constituent in the ablation plume or the analysis plume is met or exceeded; and adjusting one or more operating parameters of the laser based on the analysis of the ablation plume or analysis plume.

In accordance with another embodiment, there is provided a method of preparing a first sheet metal piece and a second sheet metal piece for welding, each of the first and second sheet metal pieces having a zinc coating layer, the method comprising the steps of: aligning the first sheet metal piece and the second sheet metal piece such that an edge portion of the first sheet metal piece faces an edge portion of the second sheet metal piece; directing a removal apparatus at the edge portions of the first and second sheet metal pieces such that a first portion of the removal apparatus is configured to impact the zinc coating layer at the edge portion of the first sheet metal piece and a second portion of the removal apparatus is configured to impact the zinc coating layer at the edge portion of the second sheet metal piece; and removing the zinc coating layer at the edge portion of the first sheet metal piece while removing the zinc coating layer at the edge portion of the second sheet metal piece with the removal apparatus until the zinc coating layer is removed from the edge portion of the first sheet metal piece and the zinc coating layer is removed from the edge portion of the second sheet metal piece.

### DRAWINGS

FIG. 1 is an image of a cross-section of a sheet metal piece having a microcrack resulting from liquid metal embrittlement (LME);

FIG. 2 schematically illustrates a prepared sheet metal piece in accordance with one embodiment;

FIG. 3 is a cross-section view of the prepared sheet metal piece of FIG. 2;

FIG. 4 is a cross-section of the prepared sheet metal piece of FIG. 2 welded to another prepared sheet metal piece;

FIG. 5 illustrates another welding configuration that may be used with prepared sheet metal pieces;

FIG. 6 illustrates yet another welding configuration that may be used with prepared sheet metal pieces;

FIG. 7 schematically illustrates a method of laser ablating a zinc coating layer in accordance with one embodiment;

FIG. 8 schematically illustrates a method of laser ablating a zinc coating layer in accordance with another embodiment;

FIG. 9 is an example analysis spectrum before the zinc coating layer is ablated;

FIG. 10 is an example analysis spectrum during the ablation process;

FIG. 11 is a cross-section of the welded sheet metal assembly of FIG. 4, after being subjected to a forming process; and

FIG. 12 is a cross-section of another welded sheet metal assembly.

### DESCRIPTION

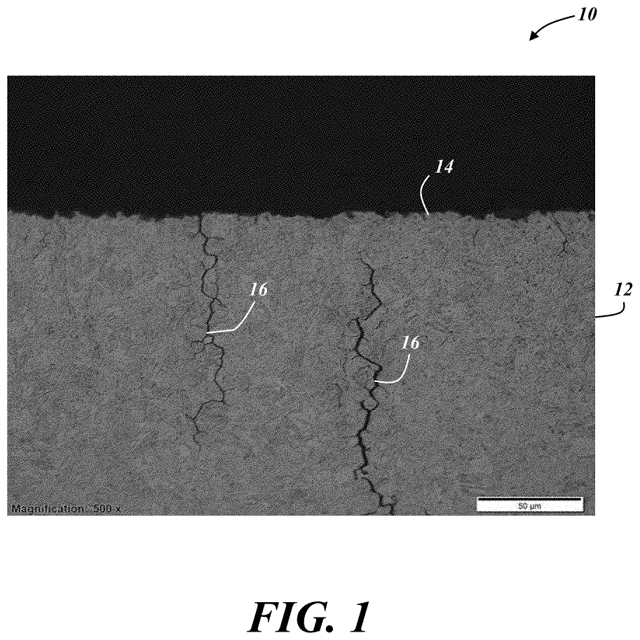

The methods described herein involve efficient and strategic removal of zinc from sheet metal pieces. Zinc coated metals, such as zinc coated steels, are widely used in applications where a particular amount of corrosion resistance is needed. For example, zinc coated steel is increasingly being used in automotive applications such as automotive body panels, automotive closures, automotive electric and hybrid vehicle body components, electric vehicle power storage and distribution components, and other structural components. These sheet metal pieces are frequently welded (e.g., to another zinc coated sheet metal piece or to another metal piece). When high temperatures are present, such as during the welding process (e.g., above 420° C.), molten zinc from the surface coating could penetrate between the metal grains. When combined with internal and/or external stresses, such as from solidification of the weld joint or clamping to cite two examples, liquid metal embrittlement (LME) may form. The LME can cause intergranular microcracking, as shown in FIG. 1.

In FIG. 1, a sheet metal piece 10 includes a base metal layer 12 of steel that is coated with a thin zinc layer 14. In this embodiment, microcracks 16 formed from the zinc-induced LME. As shown, the microcracks 16 propagate through the base metal layer 12. This intergranular microcracking can cause potential defects in subsequent operations, such as splits during forming operations after the sheet metal pieces are welded. Targeted and efficient removal of the zinc coating layer before welding and forming operations can help eliminate deleterious LME effects, and may also help avoid solid metal embrittlement (SME) as well. Moreover, finished, welded products produced by the methods described herein can have higher strength and are capable of withstanding subsequent forming operations without LME or SME related defects. Removing the zinc coating layer in accordance with the methods described herein can more precisely target the coating layer while helping to maintain the structural integrity of the base metal layer and protecting the subsurface of the base metal layer.

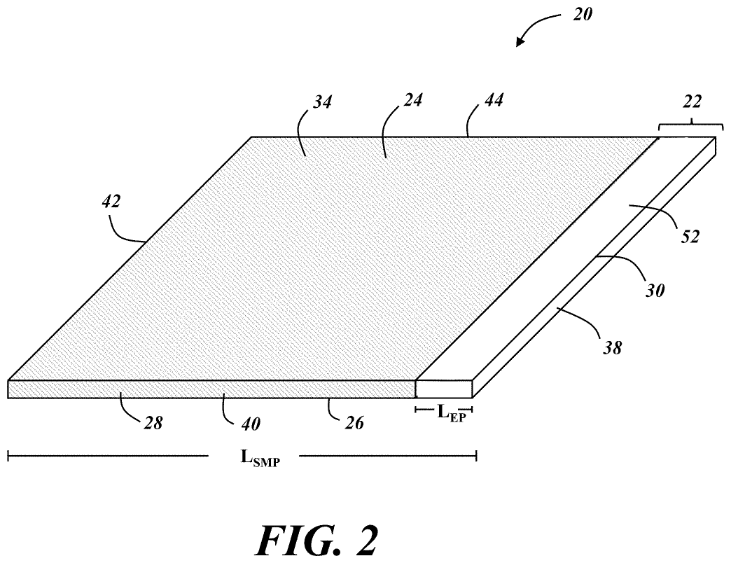

FIG. 2 illustrates a sheet metal piece 20 that is prepared in accordance with one embodiment and is to be welded to an adjacent piece along an edge portion 22. The sheet metal piece 20 includes a primary surface 24, a secondary surface 26, and a peripheral surface 28 between the primary surface 24 and the secondary surface 26. The edge portion 22 is located along a welding edge 30 that is to be welded. The welding edge 30 may be straight as shown, or it may have another shape such as a curvilinear shape. The dimensions of the edge portion 22 may vary depending on the implementation. For example, the length LEP of the edge portion 22 will likely be greater if a lap weld is desired than if a butt weld will be used. The length LEP is typically much smaller than the length of the sheet metal piece (Lsmp).

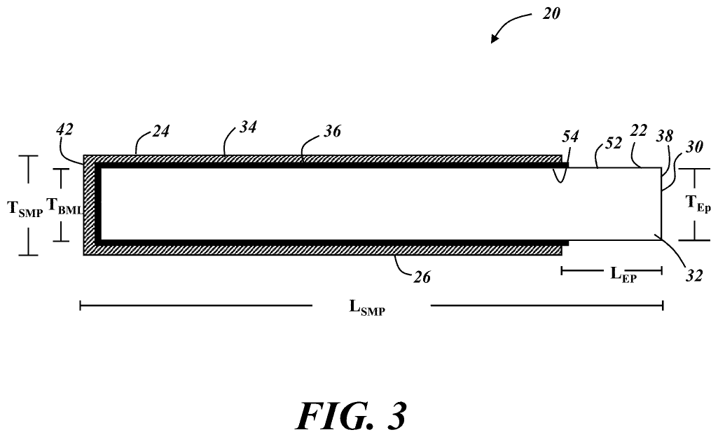

FIG. 3 is a cross-section of the sheet metal piece 20 of FIG. 2. The illustrated sheet metal piece 20 includes multiple layers, including a base metal layer 32, a zinc coating layer 34, and a possible intermediate material layer 36. In this embodiment, the base metal layer 32 is the central or core material layer (e.g., a steel core) and is sandwiched between the intermediate material layer 36 and the zinc coating layer 34. The base metal layer 32 makes up the majority of the thickness of the sheet metal piece 20 (Tsmp) and thus may contribute significantly to the mechanical properties of the sheet metal piece. As shown, the thickness of the base metal layer 32 (TBML) is a large percentage of the overall thickness Tsmp. Moreover, the difference between the thickness at the edge portion 22 (TEP) and the thickness of the base metal layer 32 (TBML) can be minimized using the methods herein. In one example, the difference between TBML and TEP is about 0.001-5% (i.e., TEP is within 0.001-5% of TBML). In another example, the difference between TBML and TEP is about 0.001-2.5%. Maintaining this small difference between TBML and TEP helps promote structural integrity of the ultimately welded and formed part and protects the subsurface of the base metal layer 32. Additionally, the thickness Tsmp is small compared to the overall area of the primary and secondary surfaces 24, 26. This results in an area of a peripheral side (four peripheral sides 38-44 are shown in the figures, although other numbers or shapes are certainly possible) that is less than an area of the primary planar surface 24 or the secondary planar surface 26 by a factor of five or more.

The zinc coating layer 34 covers the base metal layer 32 and is then selectively removed from the edge portion 22. The zinc coating layer 34 is relatively thin with respect to the base metal layer 32 and may enhance one or more characteristics of the sheet metal piece (e.g., corrosion resistance, hardness, weight, formability, appearance, etc.). The zinc coating layer 34 is typically formed by using a hot dipping process or an electrogalvanizing process. In such a process, the base metal layer 32 is dipped or submerged into a molten bath. Typically, the molten bath is about 95-99 wt % zinc with alloying elements such as aluminum, nickel, iron, and/or bismuth. The ablation process may also serve to remove other surface contaminants that may be considered part of the zinc coating layer 34, such as organics, hydrocarbons, dirt and/or oil.

The intermediate layer 36 is located between the base metal layer 32 and zinc coating layer 34, and is in contact with each in this embodiment. Although in some embodiments, there may not be an intermediate layer 36 or there may be multiple intermediate layers. In the illustrated embodiment, the intermediate material layer 36 includes at least one constituent in common with each of the immediately adjacent layers 32, 34, such as an atomic element or chemical compound. The intermediate material layer 36 may be a reaction product of the base metal and zinc coating layers 32, 34. For example, a dip coating process, in which the base metal layer is immersed or passes through a molten bath of coating layer material, can result in a chemical reaction at the interface of the base material layer and the molten bath, and the reaction product is the intermediate layer 36. In one specific example of such a dip coating process, the base metal layer 32 is made of a high-strength or hardenable steel alloy which is then dipped in a molten zinc bath (e.g., 450° C.-470° C.). The molten bath of zinc or zinc alloy reacts with the base metal layer at its surface to form the intermediate layer 36, which includes iron-zinc (Fe—Zn) intermetallic compounds. The intermediate layer 36 can have a higher content of a base metal layer constituent (e.g., iron) closer to the base metal layer 32 and a higher content of zinc closer to the zinc coating layer 34. Though shown in FIG. 3 as a perfectly planar layer with a constant thickness, the intermediate material layer 36 (or the other layers 32, 34) may be irregular along its opposite surfaces. It should also be understood that the intermediate material layer 36 (or the other layers 32, 34) is not necessarily uniform in composition throughout.

One specific example of a multi-layered sheet metal piece useful for forming body and structural components in the automotive and other industries, such as that shown in FIGS. 2 and 3, is a coated steel product in which the base metal layer 32 is made from steel in any of its various possible compositions. In one particular embodiment, the base material layer 32 is a high-strength or hardenable steel alloy such as a boron steel alloy, a dual phase steel, a press hardened steel (PHS), a high-strength low-alloy (HSLA) steel, an ultra-high-strength steel (DHSS), an advanced high-strength steel (AHSS), a generation 3 steel, or another operational type of steel. Some of these materials, while strong for their weight, may require heat treating processes to attain the high-strength properties and/or can only be formed at high temperatures (e.g., the boron steel alloy). The zinc coating layer 34 may accordingly help prevent oxidation during heat treatment of such alloys. The intermediate material layer 36 may thus include iron and zinc in the form of intermetallic compounds such as FeZn₇, FeZn₁₀, Fe₃Zn₁₀, FeZn₁₃, Fe₅Zn₂₁, or various combinations thereof. The intermediate material layer 36 may also include an alloy of constituents from adjacent layers.

Example layer thicknesses range from about 0.5 mm to about 5.0 mm for the base metal layer 32, from about 1 μm to about 15 μm for the intermediate layer 36, and from about 5 μm to about 100 μm for the zinc coating layer 34. Preferred material layer thicknesses range from about 0.5 mm to about 2.0 mm for the base metal layer 32, from about 5 μm to about 10 μm for the intermediate layer 36, and from about 15 μm to about 50 μm for the zinc coating layer 34. In one embodiment, the combined thickness of the intermediate and coating layers 34, 36 is in a range from about 15 μm to about 25 μm, and the intermediate material layer is about 20-30% of the combined thickness. For instance, the combined thickness of layers 34, 36 may be about 20 μm, where the intermediate material layer is about 4-6 μm thick, and the coating layer makes up the remainder of the combined thickness. Of course, these ranges are non-limiting, as individual layer thicknesses depend on several factors specific to the application and/or the types of materials employed. For example, the base metal layer 32 can be a material other than steel, such as alloys of aluminum, magnesium, or other suitable materials. Skilled artisans will also appreciate that the figures are not necessarily to scale and that the relative thicknesses of layers 32-36 may differ from those illustrated in the drawings and described above.

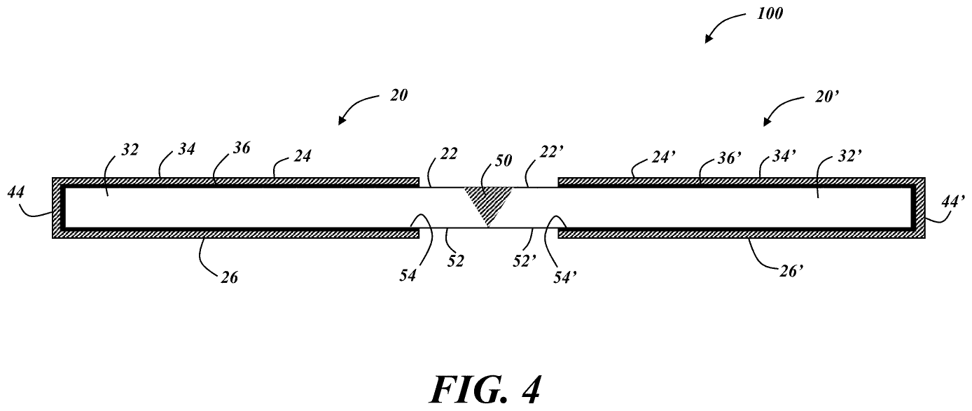

FIG. 4 shows the sheet metal piece 20, which is butt welded to a similar sheet metal piece 20′ at the weld joint 50. In some embodiments, a subsequent or contemporaneous welding process is carried out in conjunction with the removal and ablation processes described herein. Removal of the zinc coating layer 34 and/or intermediate layer 36 forms an exposed subsurface 52 of the base metal layer 32. The exposed subsurface 52 is free from both the zinc coating layer 34 and the intermediate layer 36, which helps to avoid LME and/or SME related defects in the final product. Moreover, as detailed below, the exposed subsurface 52 is very close to the actual surface 54 of the base metal layer 32 that interfaces with the intermediate layer 36 and/or the zinc coating layer 34. Minimizing the difference between the exposed subsurface 52 and the actual surface 54 can help maintain structural integrity of the welded sheet metal assembly 100. Maintaining the structural integrity by minimizing differences between the exposed subsurface 52 and/or the actual surface 54 (e.g., by minimizing the thickness difference between TBML and TEP) is balanced with the need to remove zinc from the edge portions 22, 22′ to avoid the LME and/or SME related defects. Forming the exposed subsurface 52 is advantageous in a number of implementations; however, in some embodiments, ablation and removal may only be partial (e.g., about 5-99% of the coating layer 34 is removed, or more preferably, 50-99%).

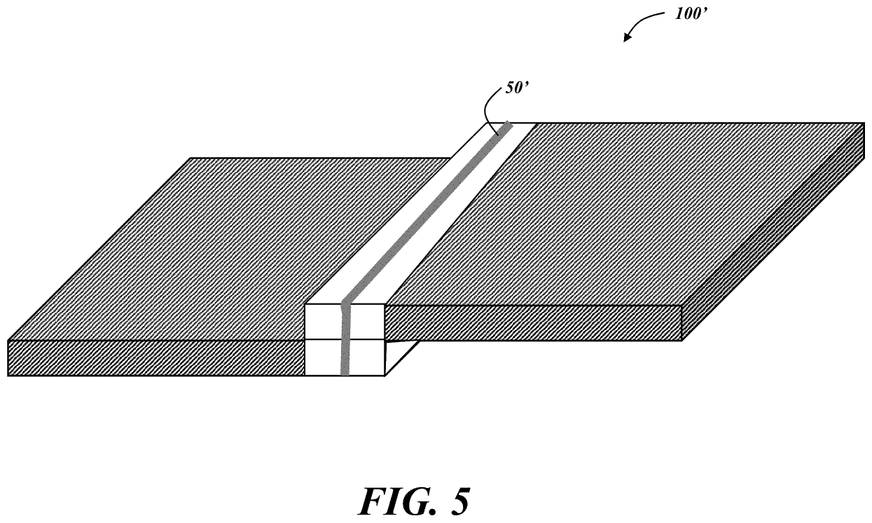

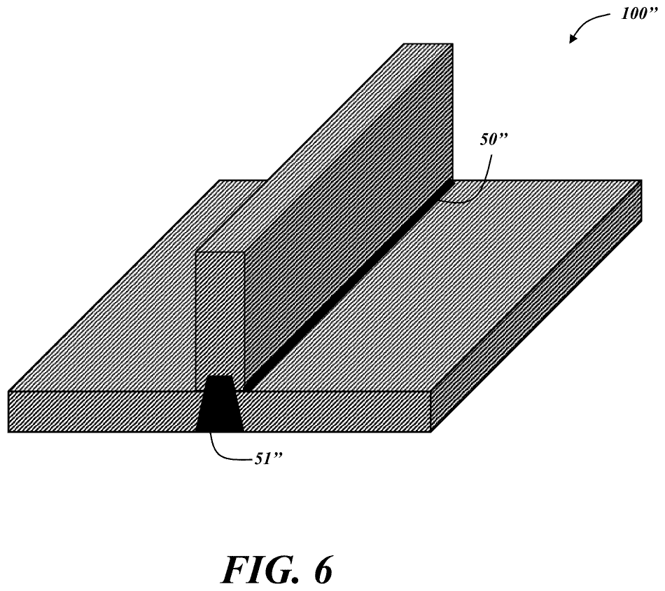

FIGS. 5 and 6 illustrate alternate welding configurations. FIG. 5 shows a welded sheet metal assembly 100′ having a weld joint 50′ in the form of a lap weld. In this embodiment, the surfaces may be prepared similarly to the embodiments of FIGS. 2 and 3. FIG. 6 shows a welded sheet metal assembly 100″ having two or more weld joints in the form of a fillet weld joint 50″ and a t-joint weld 51″. The welded assembly 100″ may have both joints 50″, 51″, or just one or the other of the joints 50″, 51″. In the FIG. 6 embodiment, the cleaned surfaces have been recoated with zinc after welding. In other embodiments, the cleaned surfaces may not be recoated after welding. Further, in this embodiment, the top sheet metal piece may be prepared similarly to the embodiments of FIGS. 2 and 3, but the bottom piece may only have a single cleaned surface along the middle of the piece.

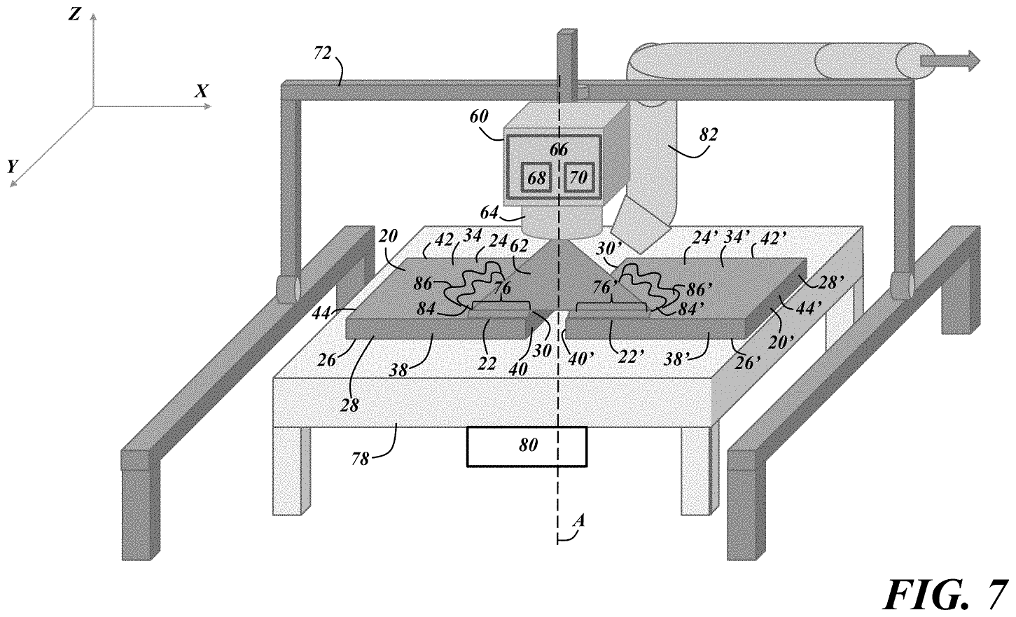

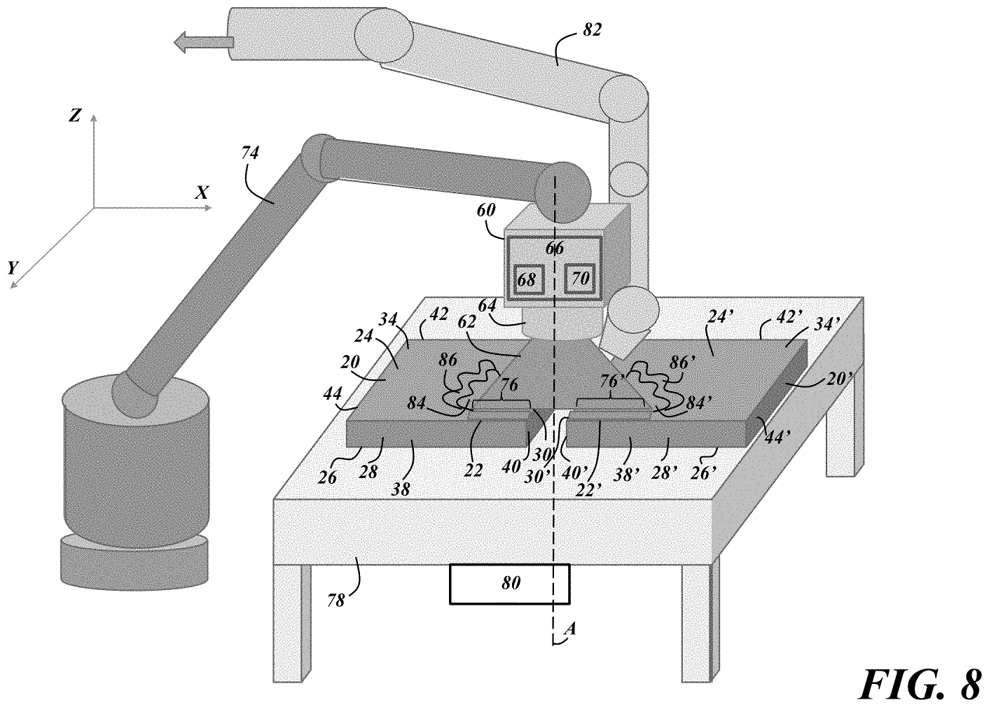

FIGS. 7 and 8 illustrate various embodiments of a method that may be used to achieve the balance between total or partial zinc removal (both the coating and intermediate layers 34, 36) to avoid LME and/or SME related defects while maintaining structural integrity at the edge portion 22. It should be noted that while the method is described in the context of preparing two sheet metal pieces 20, 20′ at the same time, whereas in some embodiments, only one sheet metal piece may be prepared at a time. In other embodiments, more than two sheet metal pieces may be prepared at a time. Preparing two sheet metal pieces at a time, as described, can improve manufacturing efficiencies as compared with methods that prepare one sheet metal piece at a time.

According to one embodiment, the method involves directing a removal apparatus 60 toward the edge portion 22 of the sheet metal piece 20. As shown in FIGS. 7 and 8, it is possible to align the first sheet metal piece 20 and the second sheet metal piece 20′ such that the edge portion 22 of the first sheet metal piece 20 faces the edge portion 22′ of the second sheet metal piece 20′. In other embodiments, however, there may be only one sheet metal piece. The removal apparatus 60 advantageously uses a scanning beam 62 of a laser delivery unit 64, but in other implementations, the removal apparatus may be a mechanical-based grinding or scraping tool. In yet other embodiments, the removal apparatus may be plasma-based, coronal-based, or chemical-based. The laser delivery unit 64 may include an optical lens to deliver the laser beam in the intended configuration (e.g., by adjusting the focal height). The removal apparatus 60 in this embodiment includes a scan controller 66 which may also include an electronic processor 68 and memory 70. The removal apparatus 60 in the illustrated implementation also includes a beam generating unit which is not shown and can be remotely located, with a laser beam being delivered to the scan controller 66 through a laser fiber, to cite one example. The scan controller 66 can adjust the dimensions and various other properties of the scanning beam 62 during the ablation process. For example, the scan controller 66 can control the shape of the beam 62 within the X-Y-Z coordinate plane. One advantage of a 3-D scanner is that both the horizontal and vertical surfaces of the sheet metal pieces 20, 20′ can be treated in one pass (e.g., the primary surface 24, 24′ and one or more of the peripheral sides 38-42). In other embodiments, a 2-D scan may be used. The area of coverage with a 2-D scan is about 300×300 mm in one embodiment, or anywhere between 200×200 mm and 400×400 mm, whereas the volume of a 3-D scan is about 300×300×100 mm, or anywhere between about 200×200×50 mm and 400×400×150 mm. These beam sizes can provide for better ablation or removal results given the spacing or gap between sheet metal pieces 20, 20′ and desired size of the edge portions 22, 22′. Further, the beam sizes and/or shapes may be different than these particular examples, and in some embodiments, the removal accomplished with the scanning beam 62 may be done in conjunction with a welding or joining process to manufacture, for example, a welded assembly 100. The controller 66 can also be used to adjust various other operating parameters of the beam 62, such as the power, the pulse duration, the wavelength, the pulse frequency, and the location of the laser 64 (e.g., via linear speed of the gantry 72 of FIG. 7 or the robot 74 of FIG. 8). In one advantageous embodiment, the laser 64 is an ultra-fast pulsed laser (e.g., in the nanosecond, picosecond, or femtosecond range of pulses), although other laser types or removal apparatus types are certainly possible.

The removal apparatus 60 is directed at the first and second sheet metal pieces 20, 20′ such that a first portion 76 of the beam 62 is configured to impact the zinc coating layer 34 at the edge portion 22 of the first sheet metal piece 20. A second portion 76′ of the beam 62 is configured to impact the zinc coating layer 34′ at the edge portion 22′ of the second sheet metal piece 20′. The first and second portions 76, 76′ of the removal apparatus 60 are symmetrical along axis A. If the power distribution across the beam 62 is not entirely uniform (e.g., a Gaussian type distribution where the power is higher toward the axis or central axis A), it may be desirable for the power distribution to be symmetrical. This symmetry of the power distribution results in symmetrical first and second portions 76, 76′, which can in turn result in more uniform treatment of the first and second sheet metal pieces 20, 20′ during simultaneous processing. In some embodiments, a second laser or removal apparatus is used simultaneously on the other side or from the underside of the first laser to ablate the secondary surface 26 at the same time as the primary surface 24 is being prepared.

Movement of the removal apparatus 60 relative to the sheet metal pieces 20, 20′ can be accomplished via the gantry 72 of FIG. 7 or the robot 74 of FIG. 8. In the illustrated embodiments, the sheet metal pieces 20, 20′ are stationary while the removal apparatus 60 is moved. The fixture table 78 can hold the sheet metal pieces 20, 20′ using mechanical, magnetic, or vacuum forces. A vacuum fixture 80 is advantageous over magnets as it can hold non-ferrous metals. Additionally, the vacuum fixture 80 may be advantageous over mechanical fixtures as it can provide a wider, more open area for the removal apparatus 60 to clean, as well as allowing for easier modification of the fixture table 78 in order to accommodate different product sizes and shapes. In another embodiment, moving tables or fixtures are used (e.g., facilitating linear or rotational movement of the sheet metal piece 20, 22′) while the removal apparatus remains stationary.

During the removal process, scanning beam 62 is configured to impact the zinc coating layer 34, 34′ at the edge portion 22, 22′. As will be detailed further below, various operating parameters may be adjusted during an in-line analysis to provide a better result where the zinc coating layer 34, 34′ is removed, while helping to maintain the structural integrity of the base metal layer 32, 32′. The zinc coating layer 34, 34′, as well as the intermediate layer 36, 36′, in certain embodiments, is completely removed to form an exposed subsurface 52, 52′ on the base metal layer 32, 32′. The zinc coating layer 34, 34′ is preferably vaporized during the ablation process and transported away from the sheet metal pieces 20, 20′ by the separation system 82. The separation system 82 may be a vacuum or another removal or transporting device that cleans the processing environment of fumes and ablated particles. Accordingly, the separation system 82 removes ablated zinc from the area near the edge region 22, 22′.

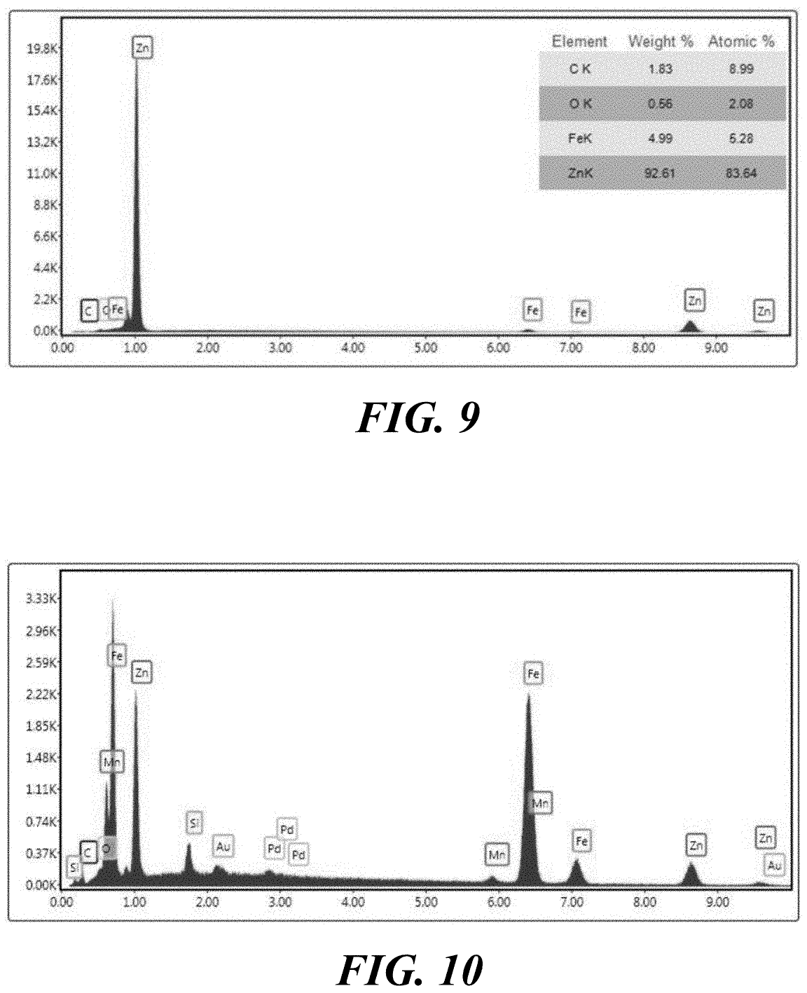

In an advantageous embodiment, the laser beam 62 is pulsed in a series of ablating pulses at the edge portion 22, 22′. The ablating pulses create an ablation plume 84, 84′ which can then be analyzed and used to adjust one or more operating parameters of the removal apparatus 60. In some embodiments, a separate laser may be used to create an analysis plume that is created by a series of analysis pulses at the edge portion 22, 22′. In the illustrated embodiment, the same laser or removal apparatus 60 is used to both ablate and analyze. The ablation plume 84, 84′ and/or the analysis plume 86, 86′ is analyzed using a visual, laser, or plasma-based inspection system. In an advantageous embodiment, the ablation plume 84, 84′ and/or the analysis plume 86, 86′ is analyzed using laser induced breakdown spectroscopy (LIBS) in which one or more pulses from laser beam 62 ablate the zinc coating layer 34, 34′ and also generate an atomic emission from the ablated particles. A LIBS spectrum or spectra can provide concentration amounts (e.g., wt %) in the ablation plume 84, 84′ and/or the analysis plume 86, 86′ which can then be used to adjust the operating parameters. The concentration amounts may be derived from a spectrum or spectra of intensity vs. wavelength. The analysis may be accomplished using scan controller 66 or another operable device. FIGS. 9 and 10 are example spectra when an Energy Dispersive Spectroscopy (EDS) analysis is used. FIG. 9 is an example analysis spectrum prior to laser ablation of the zinc coating layer, and as shown, the zinc composition is high (e.g., above 90 wt % and above 80 atomic %). During ablation, as shown in FIG. 10, the zinc drops and the iron increases.

In one example, the analyzing step continues until a threshold of at least one constituent in the ablation plume 84, 84′ and/or the analysis plume 86, 86′ is met or exceeded. In one particular embodiment, the analyzing step continues until a minimum threshold of zinc in the ablation plume 84, 84′ and/or the analysis plume 86, 86′ is met or exceeded. At that point, one or more operating parameters can be adjusted, such as moving the laser 64 along the edge portion 22, 22′. The minimum threshold of zinc may be 0.1-5 wt % or 0.5-2.5 wt % to cite two examples. The threshold may be dependent on the parameters of the laser and/or the desired form of the exposed subsurface 52, 52′ at the edge portion 22, 22′. For example, the threshold may be greater than zero, since it is likely that a minimal amount of zinc will be ablated nearest the inboard portion of the edge portion 22, 22′ (e.g., nearest the outer angled edges of the scanning beam 62), while it is completely removed to expose the base metal layer nearest edge 30, 30′. In other embodiments, the analysis may focus on an amount of iron (e.g., if steel is used for the base metal layer 32, 32′), the amount of one or more alloying elements in the zinc coating layer 34, 34′ (e.g., if the molten zinc used for coating contains aluminum, zinc, or bismuth, to cite a few examples), or the amount of other constituents in the base metal layer 32. The analysis may focus on a combination of constituents in the ablation plume 84, 84′ and/or the analysis plume 86, 86′. For example, the analysis may continue until a minimum threshold of zinc is met while a maximum threshold of iron is met. These thresholds may be adjusted based on the laser operating parameters as well as the composition of the various layers 32-36.

Based on the analysis of the ablation plume 84, 84′ and/or the analysis plume 86, 86′, one or more operating parameters of the laser 64 can be adjusted. In one embodiment, the operating parameters include the power, the pulse duration, the wavelength, the pulse frequency, and the location or speed of the laser 64. In one embodiment, the power range is in the range of approximately 10-5000 W, with one example baseline or average being 800 W. In one embodiment, the pulse duration is in the range of approximately 1-100 nsec, with one example baseline or average being 25 nsec. In one embodiment, the wavelength is in the range of approximately 850-1200 nm, with one example baseline or average being 1030 nm. In one embodiment, the pulse frequency is in the range of approximately 5-100 kHz, with one example baseline or average being 30 kHz. In one embodiment, the linear speed of the gantry 72 or robot 74 is in the range of approximately 1-25 m/min, with one example baseline or average being 6 m/min.

Feedback from the analysis may be used to adjust the operating parameters of the removal apparatus 60. For example, the amount of zinc may be monitored and the speed or position of the laser 64 may be dependent on whether the threshold minimum amount of zinc is present or exceeded. Until the threshold amount of zinc is reached, the laser may maintain a certain position or may proportionally slow the speed of the gantry 72 or robot 74. In another example, the power may be increased proportionally depending on the presence of one or more constituents. In yet another example, the wavelength may be adjusted. For example, ablation of both zinc and iron may be more effective at a particular wavelength, whereas the ablation of iron may be less effective at another wavelength. As the amount of zinc decreases, the wavelength of the laser may be adjusted to the wavelength that is less effective at ablating iron in order to preserve the structural integrity of the base metal layer 32, 32′. In yet another example, the pulse duration or pulse frequency may be adjusted. For example, the pulse duration or pulse frequency may be proportionally lessened as the zinc concentration decreases. Other example adjustments are certainly possible. Adjustment of the operating parameters using the feedback analysis described herein can more precisely form the exposed subsurface 52, 52′ of the base metal layer 32, 32′.

After the sheet metal pieces 20, 20′ are prepared, they can be laser welded at the edge portion 22, 22′ as illustrated in FIGS. 4-6. With the zinc coating layer 34, 34′ and/or the intermediate layer 36, 36′ removed, LME and/or SME defects can be prevented during the welding process and the welded assembly can maintain its structural integrity during subsequent forming processes such as stamping or drawing. Moreover, the weld may be stronger since more of the base metal layer 32, 32′ is available at the edge portion 22, 22′.

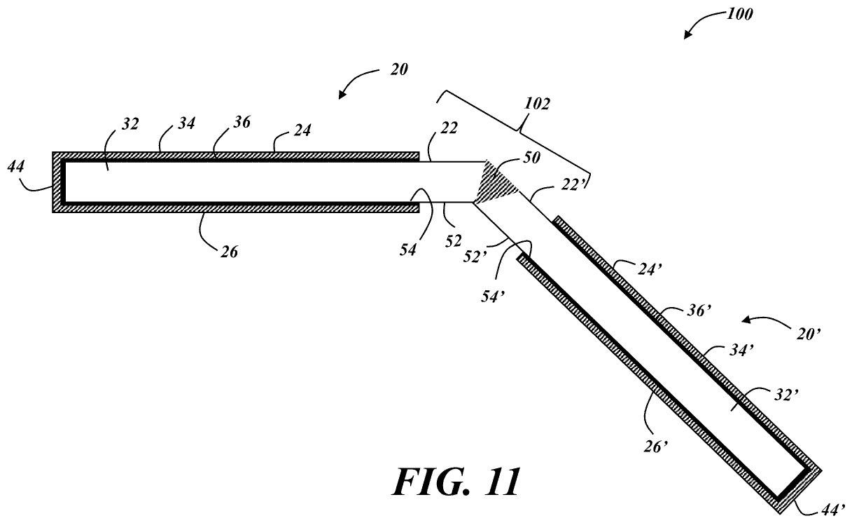

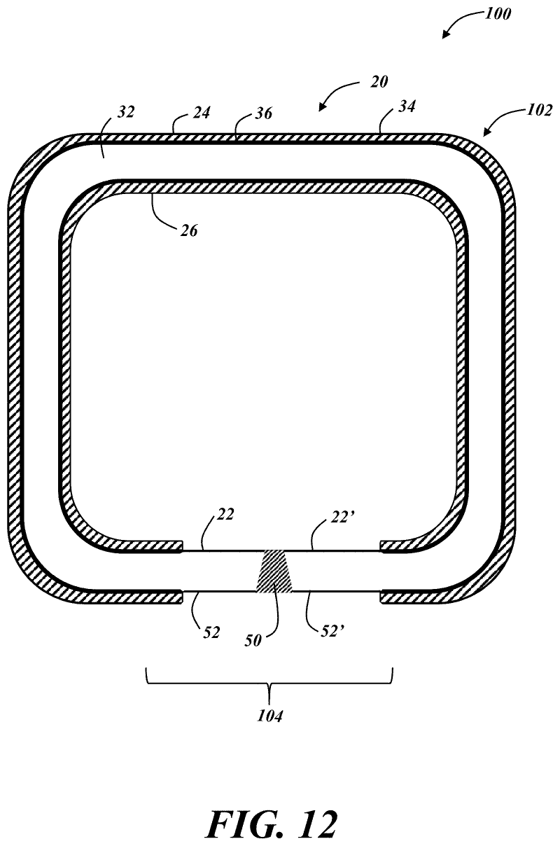

FIGS. 11 and 12 schematically illustrates example welded sheet metal assemblies 100 that includes a formed portion 102 formed via a forming process such as hot stamping, cold stamping, drawing, etc. The welded sheet metal assemblies 100 may be automotive body panels, automotive closures, automotive electric and hybrid vehicle body components, or electric vehicle power storage and distribution components, to cite a few examples. The formed portion 102 can be formed along the weld joint 50, such as the bend shown in FIG. 11, although in other embodiments, it is likely that the formed portion only crosses a portion of the weld joint 50. In FIG. 12, the welded assembly 100 is made from only a single piece 20 that includes two edge portions 22, 22′ that are welded together. The welded assembly 100 may be a battery box, or some other structure that is desirably formed from one piece that is welded together at two portions 22, 22′ that are cleaned in accordance with the methods described herein. The welded assembly 100 may be more of a tube-shape, which could be desirable in applications such as cross-car beams. Due to the preparation and removal methods described herein, a cleaned portion 104, and in some embodiments, the formed portion 102 as well, are free from LME and/or SME defects such as microcracks that propagate into the base metal layer 32, 32′.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of preparing a sheet metal piece for welding, the sheet metal piece having a zinc coating layer, the method comprising the steps of:
directing a beam of a laser at an edge portion of the sheet metal piece such that a portion of the beam is configured to impact the zinc coating layer at the edge portion, wherein the edge portion includes at least a part of a primary surface of the sheet metal piece, at least a part of a secondary surface of the sheet metal piece, and at least a part of a peripheral surface of the sheet metal piece, the peripheral surface being situated between the primary surface and the secondary surface;
pulsing the laser in a series of ablating pulses at the edge portion, wherein the ablating pulses create an ablation plume that includes ablated material from the zinc coating layer located at the primary surface and ablated material from the zinc coating layer located at the peripheral surface;
analyzing the ablation plume for the series of ablating pulses or analyzing an analysis plume created by a series of analysis pulses at the edge portion;
continuing the ablation and analyzing step until a threshold of at least one constituent in the ablation plume or the analysis plume is met or exceeded; and
adjusting one or more operating parameters of the laser based on the analysis of the ablation plume or analysis plume.

2. The method of claim 1, wherein the beam is a scanning beam and the scanning beam of the laser comprises a 2-D scan or a 3-D scan having a non-uniform power distribution across the beam that is higher toward a central axis.

3. The method of claim 2, wherein the scanning beam of the laser comprises a 2-D scan having an area of coverage that is between 200 mm×200 mm and 400 mm×400 mm, inclusive.

4. The method of claim 2, wherein the scanning beam of the laser comprises a 3-D scan having a volume of coverage that is between 200 mm×200 mm×50 mm and 400 mm×400 mm×150 mm, inclusive.

5. The method of claim 1, wherein the threshold of the at least one constituent is a minimum threshold of zinc that is 0.1-5 wt %, inclusive.

6. The method of claim 5, wherein the at least one constituent further includes iron, and the ablation and analyzing step continues until a maximum threshold of iron is met.

7. The method of claim 1, wherein the threshold of the at least one constituent includes a threshold of aluminum or a threshold of bismuth, and wherein aluminum and/or bismuth is included as an alloying element in the zinc coating layer.

8. The method of claim 1, wherein the one or more operating parameters includes a power level, a pulse duration, a wavelength, a pulse frequency, a location, and/or a speed of the laser.

9. The method of claim 1, wherein the zinc coating layer further includes other surface contaminants, and wherein the other surface contaminants includes organics, hydrocarbons, dirt, and/or oil.

10. The method of claim 1, wherein the base metal layer has a thickness, and the edge portion after the ablation and analysis step has a thickness, and wherein a difference between the thickness of the edge portion after the ablation and analysis step and the thickness of the base metal layer is within 0.001-5 %, inclusive.

11. The method of claim 1, wherein the ablation and analysis step results in total removal of the zinc coating layer at the edge portion to form an exposed subsurface of the base metal layer.

12. The method of claim 1, further comprising the step of preparing a second sheet metal piece for welding using the scanning beam of the laser on an edge portion of the second sheet metal piece, wherein the preparing of the first sheet metal piece and the preparing of the second sheet metal piece occurs simultaneously.

13. The method of claim 1, further comprising the step of welding the sheet metal piece to a second sheet metal piece at a weld joint along the edge region to form a welded sheet metal assembly.

14. The method of claim 13, further comprising the step of forming the welded sheet metal assembly to create a formed portion, wherein the formed portion includes at least a portion of the weld joint.

15. The method of claim 14, wherein the formed portion is free from liquid metal embrittlement and/or solid metal embrittlement defects.

16. The method of claim 1, wherein the removing and ablating step only partially removes the zinc coating layer.

17. The method of claim 1, wherein ablation occurs at the primary surface, at the secondary surface, and at the peripheral surface.

18. A method of preparing a first sheet metal piece and a second sheet metal piece for welding, each of the first and second sheet metal pieces having a zinc coating layer, the method comprising the steps of:
aligning the first sheet metal piece and the second sheet metal piece such that an edge portion of the first sheet metal piece faces an edge portion of the second sheet metal piece;
directing a removal apparatus at the edge portions of the first and second sheet metal pieces such that a first portion of the removal apparatus is configured to impact the zinc coating layer at the edge portion of the first sheet metal piece and a second portion of the removal apparatus is configured to impact the zinc coating layer at the edge portion of the second sheet metal piece; and
removing the zinc coating layer at the edge portion of the first sheet metal piece while removing the zinc coating layer at the edge portion of the second sheet metal piece with the removal apparatus until the zinc coating layer is removed from the edge portion of the first sheet metal piece and the zinc coating layer is removed from the edge portion of the second sheet metal piece.

19. The method of claim 18, wherein the removal apparatus is a scanning beam of a laser and the removing step includes ablating the zinc coating layer at the edge portion of the first sheet metal piece while ablating the zinc coating layer at the edge portion of the second sheet metal piece.

20. The method of claim 18, wherein the removal apparatus is mechanical-based, coronal-based, plasma-based, laser-based, or chemical-based.

21. The method of claim 18, wherein the removing step includes partial removal of the zinc coating layer of the first sheet metal piece and partial removal of the zinc coating layer of the second sheet metal piece.

22. The method of claim 21, wherein the removing step is performed in conjunction with a welding step that welds the first and second sheet metal pieces.

23. The method of claim 18, wherein the removing step includes total removal of the zinc coating layer to form an exposed subsurface on a base metal layer of the first sheet metal piece and total removal of the zinc coating layer to form an exposed subsurface on a base metal layer of the second sheet metal piece.

24. The method of claim 23, wherein the removing step is performed in conjunction with a welding step that welds the first and second sheet metal pieces.

25. The method of claim 18, wherein the removing step comprises removing the zinc coating layer at a primary surface and a peripheral surface at the first sheet metal piece while removing the zinc coating layer at a primary surface and a peripheral surface at the second sheet metal piece.
